(19) United States
(12) Patent Application Publication
(10) Pub. No.: US 2024/0100740 A1
(43) Pub. Date: Mar. 28, 2024

(54) Roll Mill for Super Absorbent Polymer and Method for Preparing Super Absorbent Polymer Using the Same

(71) Applicant: LG Chem, Ltd., Seoul (KR)

(72) Inventors: Seokhyeon Baek, Daejeon (KR); Gicheul Kim, Daejeon (KR); Yoon Jae Min, Daejeon (KR)

(73) Assignee: LG Chem, Ltd., Seoul (KR)

(21) Appl. No.: 18/270,310

(22) PCT Filed: Jul. 8, 2022
(86) PCT No.: PCT/KR2022/009900

§ 371 Date: Jun. 29, 2023

(30) Foreign Application Priority Data
Jul. 12, 2021 (KR) 10-2021-0091027
Jul. 7, 2022 (KR) 10-2022-0083939

(51) Int. Cl. B29B 13/10; B29B 7/58; B29B 9/12; C08F 120/06; C08J 3/075; C08J 3/12

(52) U.S. Cl. CPC B29B 13/10; B29B 7/588; B29B 9/12; C08F 120/06; C08J 3/075; C08J 3/12; B29K 2105/251; C08J 2333/02

(57) ABSTRACT

A roll mill for super absorbent polymer that grinds introduced super absorbent polymer particles and discharges them. The roll mill for super absorbent polymer includes at least one pair of rollers that have plural corrugations formed on each outer perimeter surface of the roller, and are arranged parallel to each other while being spaced by a roll gap, and the number of corrugations per unit circumference of the roller may be 0.89/mm˜1.15/mm. Also disclosed is a method for preparing super absorbent polymer using the roll mill.

### CROSS-REFERENCE TO RELATED APPLICATION

The present application is a national phase entry under 35 U.S.C § 371 of International Application No. PCT/KR2022/009900 filed on Jul. 8, 2022, which claims the benefit of priority based on Korean Patent Application No. 10-2021-0091027 filed on Jul. 12, 2021, and Korean Patent Application No. 10-2022-0083939 filed on Jul. 7, 2022, the disclosures of which are incorporated herein by reference.

### BACKGROUND ART

### (A) Technical Field

This disclosure relates to a roll mill for super absorbent polymer and a method for preparing super absorbent polymer using the same, and more specifically, to a roll mill for super absorbent polymer that can reduce particle size and realize narrow particle size distribution without increasing the amount of fine particles generated, by controlling specifications of a roll gap and roll corrugations, and a method for preparing super absorbent polymer using the same.

### (b) Description of the Related Art

Super absorbent polymer (SAP) is polymer material in the form of white powder prepared by reacting acrylic acid with caustic soda, and it can absorb moisture of about five hundred to thousand times of its own weight. The super absorbent polymer is synthetic polymer material that is transformed to a jelly-like form, if it absorbs water, and can store water without discharging, even if a certain degree of pressure is applied from the outside.

Super absorbent polymer molecules have a network structure, and due to many pores between the molecules, easily absorb water. Due to concentration difference between ions in the super absorbent polymer and water, water moves inside super absorbent polymer (by osmosis). If water molecules are introduced inside super absorbent polymer, anions fixed inside try to occupy a specific space by repulsive force, and thus, the space of polymer chains expands and more water can be absorbed (electrostatic repulsion).

Such super absorbent polymer began to be commercialized as sanitary items, and currently, is being widely used as water-holding material for soil, water stop material for civil engineering and architecture, sheets for raising seedling, freshness preservatives in the field of food circulation, fomentation material, and the like, besides hygiene products such as diapers for children, and the like.

Recently, there is an increasing demand for rapid absorption speed of super absorbent polymer for improvement of performances of diapers, and the like. In order to increase absorption speed, a method of preparing porous particles through foaming, a method of increasing shear during chopping, or a method of increasing the surface area of particle, for example, by making particle diameter small through control of a roll gap are mainly used.

If a roll gap is reduced so as to prepare small particles, particle size distribution may become broad, thus causing unbalance between product properties and difficulty in surface treatment (for example, surface crosslinking). And, the rate of fine particles having particle size less than 150 μm may increase. Since the fine particles are reassembled by adding water, and then, recycled to drying/grinding/classifying process, as the amount of fine particles generated increases, process load may increase and productivity may be deteriorated.

The background part has been described for better understanding of the background of the disclosure, and may comprise information other than prior art, already known to an ordinary skilled person in the art.

### SUMMARY

According to the embodiments of the invention, there are provided a roll mill for super absorbent polymer that can reduce particle size and realize narrow particle size distribution without increasing the amount of fine particles generated, by controlling specifications of a roll gap and roll corrugations, and a method for preparing super absorbent polymer using the same.

The roll mill for super absorbent polymer according to the embodiment of the invention grinds introduced super absorbent polymer particles and discharges them. The roll mill for super absorbent polymer comprises one pair of rollers that have plural corrugations formed on each outer perimeter surface, and are arranged parallel to each other while being spaced by a roll gap, wherein plural corrugations are formed on the outer perimeter surface of the roller, and the number of corrugations per unit circumference of the roller may be 0.89/mm˜1.15/mm.

The height of the corrugation may be 276 μm˜354 μm, and the pitch of the corrugation may be 0.87 mm˜1.12 mm.

According to one embodiment, the roll gap may be 0.10 mm˜0.25 mm.

According to another embodiment, the roll gap may be 0.10 mm˜0.20 mm.

The roll mill for super absorbent polymer may further comprise another pair of rollers arranged upstream of the one pair of rollers according to the size of introduced super absorbent polymer particles.

Said another pair of rollers have different plural corrugations formed on each outer perimeter surface, and are arranged parallel to each other while being spaced by different roll gap, and the number of different corrugations per unit circumference of each roller may be 0.25/mm˜0.38/mm.

The height of the different corrugation may be 950 μm˜1400 μm, and the pitch of the different corrugation may be 2.62 mm˜3.93 mm.

The different roll gap may be 0.20 mm˜0.30 mm.

The method for preparing super absorbent polymer according to the embodiment of the invention comprises steps of: polymerizing a monomer composition comprising water soluble ethylenically unsaturated monomers having at least partially neutralized acid groups, an internal crosslinking agent, and a polymerization initiator to prepare hydrogel polymer; chopping or micronizing the hydrogel polymer; drying the micronized hydrogel polymer to prepare dried super absorbent polymer particles; and grinding dried super absorbent polymer particles; wherein the grinding step is conducted using the roll mill according to the embodiment of the invention.

The method for preparing super absorbent polymer according to another embodiment of the invention comprises steps of: polymerizing a monomer composition comprising water soluble ethylenically unsaturated monomers having acid, an internal crosslinking agent, and a polymerization initiator to prepare hydrogel polymer; neutralizing at least a part of the acid groups of the polymer; micronizing the polymer in the presence of a surfactant to prepare hydrated super absorbent polymer particles; drying the hydrated super absorbent polymer particles to prepare dried super absorbent polymer particles; and grinding dried super absorbent polymer particles; wherein the grinding step is conducted using the roll mill according to the embodiment of the invention.

According to the embodiment of the invention, particle size can be reduced and narrow particle size distribution can be realized without increasing the amount of fine particles generated, by using rollers with increased number of corrugations.

And, while realizing the same particle distribution, a roll gap may be increased. Thus, collision of one pair of rollers may be decreased.

Besides, effects that can be obtained or expected from the embodiments of the invention will be directly disclosed or suggested in the detailed explanations of the embodiments of the invention. Namely, various effects expected according to the embodiments of the invention will be disclosed in the detailed description described later.

### BRIEF DESCRIPTION OF THE DRAWINGS

The embodiments of the invention will be better understood referring to the explanations below in relation to attached drawings where similar numeral references indicate identical or functionally similar elements.

FIG. 1 is a perspective view of the roll mill for super absorbent polymer according to the embodiment of the invention.

FIG. 2 is a schematic view showing the specifications of the rollers.

It should be understood that the drawings referred to above are not necessarily drawn to scale, and present simple expressions of various preferred characteristics illustrating the basic principle of the technology. For example, specific design characteristics comprising specific dimensions, directions, locations and shapes will be partly determined by specifically intended application and use environments.

### DETAILED DESCRIPTION

The terms used herein are only to explain specific embodiments, and are not intended to limit the technology. A singular expression includes a plural expression thereof, unless it is expressly stated or obvious from the context that such is not intended. As used herein, the terms “comprise”, “comprising”, “contains”, “containing”, etc. are intended to designate the existence of practiced characteristic, number, step, constructional element or combinations thereof, and they are not intended to preclude the possibility of existence or addition of one or more other characteristics, numbers, steps, constructional elements or combinations thereof. As used herein, the term “and/or” includes one of enumerated items in connection, or all the combinations.

As used herein, the term “polymer” means a polymerized state of water soluble ethylenically unsaturated monomers, and it may include those of all moisture content ranges or particle diameter ranges. Among the polymers, polymer after polymerization and before drying, and having a moisture content of about 40 wt % or more, may be referred to as hydrogel polymer.

And, the term “super absorbent polymer” means the polymer or base resin itself, or is used to include the polymer or base resin made appropriate for productization through additional process, for example, surface crosslinking, fine particles reassembling, drying, grinding, classification, and the like.

The roll mill for super absorbent polymer according to the embodiment of the invention can reduce particle size and realize narrow particle size distribution without increasing the amount of fine particles generated, by using rollers with increased number of corrugations. And, since the number of corrugations of the roller is increased, even if a roll gap is increased, the same particle size may be realized.

Hereinafter, the roll mill for super absorbent polymer according to the embodiment of the invention will be explained in detail with reference to the attached drawings.

The roll mill for super absorbent polymer according to the embodiment of the invention is used in the grinding step in the preparation method of super absorbent polymer.

A method for preparing super absorbent polymer according to one example (preparation method 1) may comprise steps of: polymerizing a monomer composition comprising water soluble ethylenically unsaturated monomers having at least partially neutralized acid groups, an internal crosslinking agent, and a polymerization initiator to prepare hydrogel polymer; chopping or micronizing the hydrogel polymer; drying the micronized hydrogel polymer to prepare dried super absorbent polymer particles; and grinding dried super absorbent polymer particles.

A method for preparing super absorbent polymer according to another example (preparation method 2) may comprise steps of: polymerizing a monomer composition comprising water soluble ethylenically unsaturated monomers having acid groups, an internal crosslinking agent, and a polymerization initiator to prepare hydrogel polymer; neutralizing at least a part of the acid groups of the polymer; micronizing the polymer in the presence of a surfactant to prepare hydrated super absorbent polymer particles; drying the hydrated super absorbent polymer particles to prepare dried super absorbent polymer particles; and grinding dried super absorbent polymer particles.

In the preparation method 2, the step of conducting polymerization of the monomer composition to form polymer may be conducted in a batch type reactor.

In the polymerization step, a reducing agent forming a Redox couple with a polymerization initiator may be introduced together to initiate polymerization.

In the step of neutralizing at least a part of the acid groups of the polymer, and the step of micronizing the polymer in the presence of a surfactant to prepare hydrated super absorbent polymer particles may be sequentially or simultaneously conducted.

The step of drying hydrated super absorbent polymer particles may be conducted by moving type drying.

As explained above, dried super absorbent polymer particles prepared through the polymerization step, micronizing step and drying step are ground through the grinding step using the grinding apparatus for super absorbent polymer according to the embodiment of the invention.

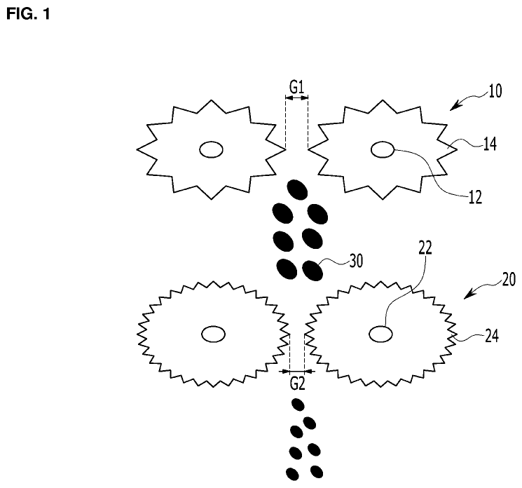

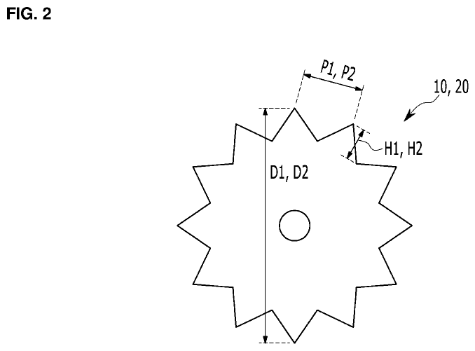

Hereinafter, referring to FIG. 1 and FIG. 2, the grinding apparatus for super absorbent polymer according to the embodiment of the invention will be explained in more detail. According to the embodiment of the invention, a roll mill having plural corrugations formed on the outer perimeter surface is used as the grinding apparatus.

FIG. 1 is a perspective view of the roll mill for super absorbent polymer according to the embodiment of the invention.

As shown in FIG. 1 and FIG. 2, the roll mill for super absorbent polymer according to the embodiment of the invention grinds introduced super absorbent polymer particles and discharges them. The roll mill comprises one pair or two pairs of rollers (10, 20). Although it is shown in FIG. 1 that the roll mill comprises one pair of first rollers (10) and one pair of second rollers (20), the roll mill may only have one pair of first rollers (10). Whether a roll mill comprising one pair of rollers (10) is used or a roll mill comprising two pairs of rollers (10, 20) is used, is determined according to the average size of super absorbent polymer particles introduced in the roll mill. For example, if the average size of super absorbent polymer particles introduced in the roll mill is relatively large (for example, about 1850 μm or more), a roll mill comprising two pairs of roller (10, 20) may be used, and if the average size of super absorbent polymer particles introduced in the roll mill is relatively small (for example, less than about 1850 μm), a roll mill comprising one pair of rollers (10) may be used.

Each roller (10, 20) is arranged so as to rotate around the rotation axis (12, 22), and plural corrugations (14, 24) are formed on the outer perimeter surface thereof. The first rollers (10) can rotate around the first rotation axis (12), and the second rollers (20) can rotate around the second rotation axis (22). Each roller (10, 20) may have a cylindrical shape with predetermined diameter and predetermined length. And, the shape and number of the plural corrugations (14, 24) may be predetermined. For example, the corrugations (14, 24) may have a sharp apex, but they are not limited thereto.

The diameter and length of the first rollers (20) may be identical to the diameter and length of the second rollers (20). And, the number of the first corrugations (14) formed on the outer perimeter surface of the first rollers (10) may be identical to or different from the number of the second corrugations (24) formed on the outer perimeter surface of the second rollers (20). As shown in FIG. 1, the number of the first corrugations (14) formed on the outer perimeter surface of the first rollers (10) may be different from the number of the second corrugations (24) formed on the outer perimeter surface of the second rollers (20), and it may be smaller than the number of the second corrugations (24).

Each pair of rollers (10, 20) are arranged parallel to each other while being spaced by a roll gap (G1, G2). Wherein, the roll gap (G1, G2) is the minimum distance between one pair of rollers (10, 20), for example, the minimum value among the distances between the apex of the corrugation (14) of one roller (10), and the apex of the corrugation (14) of the other roller (10) arranged parallel. One pair of first rollers (10) are arranged parallel to each other while being spaced by the first roll gap (G1), and one pair of second rollers (20) are arranged parallel to each other while being spaced by the second roll gap (G2). The first roll gap (G1) may be identical to or different from the second roll gap (G2).

One pair of the second rollers (20) may be arranged downstream of the one pair of the first rollers (10)(For example, below one pair of the first rollers (10)). Thus, dried super absorbent polymer particles (30) may be fed between one pair of the first rollers (10) and primarily ground, and the primarily ground super absorbent polymer particles (30) may be fed again between one pair of the second rollers (20) and secondarily ground.

FIG. 2 is a schematic view showing the specifications of the roller.

As described above, since the diameter (D1) of the first roller (10) is identical to the diameter (D2) of the second roller (20) and the number of the first corrugations (14) is different from the number of the second corrugations (24), the specifications of the first corrugations (14) are different from the specifications of the second corrugations (24). Specifically, the first corrugation (14) has a first height (H1) and a first pitch (P1), and the second corrugation (24) has a second height (H2) and a second pitch (P2). Wherein, the height of the corrugation indicates a distance from an imaginary circle connecting the bases of the corrugations to the apex of the corrugation, and the pitch of the corrugation indicates a distance between the apexes of the corrugations.

According to the embodiment of the invention, the size of particles and the amount of fine particles generated through the roll mill are controlled by controlling the specifications of the corrugations. Since the diameters (D1, D2) of the first, second rollers (10, 20) used in the roll mill are identical, the specifications of corrugations are controlled by controlling the number of corrugations. However, the technology is not limited to the embodiments wherein the diameters (D1, D2) of the first, second rollers (10, 20) are identical. Thus, the specifications of corrugations may be controlled by controlling the number of corrugations per unit circumference.

According to one example, on a roller (10, 20) having a diameter (D1, D2) of 250 mm, 250 corrugations (14, 24) may be formed. In this example, the number of corrugations per unit circumference is about 0.32/mm, and the height (H1, H2) of the corrugation (14, 24) is 1190 μm, and the pitch (P1, P2) of the corrugations (14, 24) is 3.14 mm.

According to another example, on a roller (10, 20) having a diameter (D2, D2) of 250 mm, 500 corrugations (14, 24) may be formed. In this example, the number of corrugations per unit circumference is about 0.64/mm, and the height (H1, H2) of the corrugation (14, 24) is 530 μm, and the pitch (P1, P2) of the corrugations (14, 24) is 1.57 mm.

According to yet another example, on a roller (10, 20) having a diameter (D1, D2) of 250 mm, 800 corrugations (14, 24) may be formed. In this example, the number of corrugations per unit circumference is about 1.02/mm, and the height (H1, H2) of the corrugation (14, 24) is 310 μm, and the pitch (P1, P2) of the corrugations (14, 24) is 0.98 mm.

As such, when the diameters of the rollers used in the roll mill for super absorbent polymer are identical, if the number of corrugations is determined, the specifications of corrugations are also determined.

As explained above, if the average size of super absorbent polymer introduced in the roll mill is relatively large (for example, about 1850 μm or more), a roll mill comprising two pairs of the first, second rollers (10, 20) is used to sequentially reduce the particle size. Thus, the number of the first corrugations (14) of the first rollers (10) is smaller than the number of the second corrugations (24) of the second rollers (20). According to one example, the number of the first corrugations (14) of the first rollers (10) may be 250 (the number of corrugations per unit circumference is about 0.32/mm), and the number of the second corrugations (24) of the second rollers (20) may be 800 (the number of corrugations per unit circumference is about 1.02/mm). In this example, the first height (H1) of the first corrugations (14) is 1190 μm and the first pitch (P1) of the first corrugations (14) is 3.14 mm, and the second height (H2) of the second corrugations (24) is 310 μm and the second pitch (P2) of the second corrugations (24) is 0.98 mm. According to another example, the number of the first corrugations (14) of the first rollers (10) may be about 200˜about 300 (the number of corrugations per unit circumference is about 0.25/mm˜about 0.38/mm), and the number of the second corrugations (24) of the second rollers (20) may be about 700˜about 900 (the number of corrugations per unit circumference is about 0.89/mm˜about 1.15/mm). In this example, the first height (H1) of the first corrugations (14) is about 950 μm˜about 1400 μm and the first pitch (P1) of the first corrugations (14) is about 2.62 mm˜about 3.93 mm, and the second height (H2) of the second corrugations (24) is about 276 μm˜about 354 μm and the second pitch (P2) of the second corrugations (24) is about 0.87 mm˜about 1.12 mm.

And, in order to sequentially reduce particle size, the first roll gap (G1) between one pair of the first rollers (10) may be relatively large, and the second roll gap (G2) between one pair of the second rollers (20) may be relatively small. According to one example, the first roll gap (G1) between one pair of the first rollers (10) may be about 0.20 mm˜about 0.30 mm. However, according to the embodiment of the invention, since the number of the second corrugations (24) of the second roller (20) is as large as 800 (the number of corrugations per unit circumference is about 1.02/mm), which is sufficient to produce small size particles, the second roll gap (G2) between one pair of the second rollers (20) may be set within a relatively wide range. For example, the second roll gap (G2) between one pair of the second rollers (20) may be about 0.10 mm˜about 0.25 mm.

If the average size of super absorbent polymer particles introduced in the roll mill is relatively small (for example, less than about 1850 μm), a roll mill comprising one pair of the first rollers (10) may be used. According to one example, the number of the first corrugations (14) of the first rollers (10) may be 800 (the number of corrugations per unit circumference is about 1.02/mm). In this example, the first height (H1) of the first corrugations (14) is 310 μm, and the first pitch (P1) of the first corrugations (14) is 0.98 mm. According to another example, the number of the first corrugations (14) of the first rollers (10) may be about 700˜about 900 (the number of corrugations per unit circumference is about 0.89/mm˜about 1.15/mm). In this example, the first height (H1) of the first corrugations (14) is about 276 μm˜about 354 μm and the first pitch (P1) of the first corrugations (14) is about 0.87 mm˜about 1.12 mm. And, the first roll gap (G1) between one pair of the first rollers (10) may be about 0.15 mm˜about 0.25 mm.

According to the embodiment of the invention, particle size may be reduced and narrow particle size distribution may be realized without increasing the amount of fine particles generated, by increasing the number of corrugations of at least one pair of rollers included in the roll mill.

Thus, super absorbent polymer prepared according to the embodiment of the invention may have small weight average particle diameter (D50) of 300 μm or more, or 320 μm or more, or 330 μm or more, or 340 μm or more, or 350 μm or more, and 440 μm or less, or 420 μm or less, or 410 μm or less, or 400 μm or less, or 380 μm or less, or 370 μm or less, or 360 μm or less, as measured according to ERT420.2-02.

Super absorbent polymer prepared according to the embodiment of the invention may comprise particles having particle diameters of 300 μm or more and less than 400 μm, in the content of 16 wt % or more, or 17 wt % or more, or 20 wt % or more, or 22 wt % or more, or 24 wt % or more, or 25 wt % or more, and 40 wt % or less, or 38 wt % or less, or 36 wt % or less, or 35 wt % or less, based on the total weight of super absorbent polymer, and thus, selectivity to particles having median particle diameters may increase to realize narrow particle size distribution.

Super absorbent polymer prepared according to the embodiment of the invention may comprise particles having particle diameters of 600 μm or more and less than 800 μm, in the content of 12 wt % or less, or 11 wt % or less, or 10 wt % or less, or 8 wt % or less, or 6 wt % or less, or 5 wt % or less, or 4 wt % or less, and 0.5 wt % or more, or 1.0 wt % or more, or 1.5 wt % or more, and particles having particle diameters of 800 μm or more, in the content of 1.0 wt % or less, or 0.9 wt % or less, or 0.8 wt % or less, or 0.7 wt % or less, or 0.6 wt % or less, or 0.5 wt % or less, or 0.4 wt % or less, and 0 wt % or more, or 0.1 wt % or more, or 0.2 wt % or more, based on total the weight of super absorbent polymer, and thus, have particle size distribution in which particles having large particle diameters are remarkably reduced.

Despite the narrow particle size distribution in which the content of particles having particle diameters less than 150 μm is 15 wt % or less, or 14 wt % or less, or 13 wt % or less, or 12 wt % or less, and 1 wt % or more, or 5 wt % or more, or 6 wt % or more, or 7 wt % or more, based on the total weight of super absorbent polymer, low fine particle generation may be exhibited.

The method for preparing super absorbent polymer according to the embodiment of the invention may further comprise a step of classifying the ground super absorbent polymer particles according to particle diameter, after the step of grinding the super absorbent polymer particles.

And, the method for preparing super absorbent polymer according to the embodiment of the invention may further comprise a surface crosslinking step in which a surface crosslink layer is formed on at least a part of the surfaces of the super absorbent polymer particles, in the presence of the surface crosslinking agent, after grinding and/or classifying the super absorbent polymer particles. By the surface crosslinking step, crosslinked polymer included in the super absorbent polymer particles is additionally crosslinked by the surface crosslinking agent, thus forming a surface crosslink layer on at least a part of the surfaces of the super absorbent polymer particles.

Hereinafter, the aspects of the embodiments of the invention will be explained through Examples and Comparative Examples.

### Examples 1 to 5 and Comparative Examples 1 to 4

(First Preparation Method of Super Absorbent Polymer)

Based on 100 g of acrylic acid, 10 ppm of polyethyleneglycol diacrylate internal crosslinking agent, and 80 ppm of IRGACURE 819 photoinitiator were introduced and mixed to prepare a monomer solution. Subsequently, the monomer solution was continuously mixed with 123 g of an aqueous solution of 31.5% sodium hydroxide through a pump to prepare a neutralized monomer solution. Wherein, after confirming that the temperature of the neutralized monomer solution increased to about 72° C. or more by neutralization heat, we waited until the temperature was decreased to 40° C. When the temperature was decreased to 40° C., 1000 ppm of solid phase capsule type blowing agent F-36D and 56 ppm of an aqueous solution of 28% lauryl sodium sulfate were added to the neutralized monomer solution, and simultaneously, 1250 ppm of sodium persulfate thermal initiator and 2400 ppm of ethylene glycol diglycidyl ether internal crosslinking agent were added. The solution was poured into a polymerization reactor equipped with a light irradiation apparatus and pre-heated to 80° C., and light irradiation was conducted to photoinitiate. After light irradiation for 1 minute, reaction was additionally conducted for 2 minutes to obtain hydrogel polymer in the form of sheet.

1600 g of the hydrogel polymer was cut to a size of about 3 cm length, 3 cm height, and mixed with 63 g of water, and then, poured into a chopper having a hole size of 16 mm to chop the hydrogel polymer sheet. The chopped gel was dried by fixed-bed type drying at 180° C. for 34 minutes in a convection dryer. And then, dried chips were coarsely ground through a cutter mill. Wherein, the average particle size was 2393 μm.

### Comparative Example 1

The super absorbent polymer obtained through the first preparation method was ground using one pair of first rollers (10) wherein the number of first corrugations (14) is 250 (the number of corrugations per unit circumference is about 0.32/mm, H1=1190 μm, P1=3.14 mm) and the first roll gap (G1) is 0.3 mm, and one pair of second rollers (20) wherein the number of second corrugations (24) is 500 (the number of corrugations per unit circumference is about 0.64/mm, H2=530 μm, P2=1.57 mm) and the second roll gap (G2) is 0.2 mm. And then, particle size distribution was analyzed using mesh type classification sieve.

### Comparative Example 2

The same process as Comparative Example 1 was conducted, except that the second roll gap (G2) was 0.15 mm.

### Comparative Example 3

The same process as Comparative Example 1 was conducted, except that the second roll gap (G2) was 0.10 mm.

### Example 1

The same process as Comparative Example 1 was conducted, except using one pair of second rollers (20) wherein the number of second corrugations (24) is 800 (the number of corrugations per unit circumference is about 1.02/mm, H2=310 μm, P2=0.98 mm), and the second roll gap (G2) is 0.25 mm.

### Comparative Example 4

The same process as Example 1 was conducted, except that the second roll gap (G2) was 0.30 mm.

### Example 2

The same process as Example 1 was conducted, except that the second roll gap (G2) was 0.20 mm.

### Example 3

The same process as Example 1 was conducted, except that the second roll gap (G2) was 0.15 mm.

### Example 4

The same process as Example 1 was conducted, except that the second roll gap (G2) was 0.10 mm.

### Example 5

The same process as Example 4 was conducted, except using one pair of first rollers (10) wherein the number of first corrugations (14) is 250 (the number of corrugations per unit circumference is about 0.32/mm, H2=1190 μm, P2=3.14 mm), and the first roll gap (G2) is 0.2 mm.

### Experimental Example

For the super absorbent polymers obtained in Examples and Comparative Examples, properties were measured as follows.

In the following, evaluations of centrifuge retention capacity, vortex time, and one minute absorption capacity were conducted for super absorbent polymer having particle diameter of 300 μm˜425 μm.

(1) Centrifuge Retention Capacity (CRC)

For each polymer, centrifuge retention capacity by absorption rate under no load was measured according to EDANA WSP 241.3.

Specifically, W₀ (g) (about 0.2 g) of super absorbent polymer was uniformly put in an envelope made of non-woven fabric, and sealed, and then, soaked in physiological saline (0.9 wt %) at room temperature. After 30 minutes, the envelop was drained under 250G for 3 minutes using a centrifuge, and the weight of the envelope, W₂ (g), was measured. And, the same operation was conducted without polymer, and the weight at that time, W₁ (g), was measured. Using the obtained masses, CRC (g/g) was calculated according to the following Calculation Formula 1.

CRC (g/g)={[W₂(g)−W₁(g)]/W₀(g)}−1 [Calculation Formula 1]

(2) Vortex Time

A vortex time was measured according to Japanese Standard Method (JIS K 7224).

Specifically, in 50 mL of physiological saline of 25° C., 2 g of super absorbent polymer was introduced, and stirred with a magnetic bar (diameter 8 mm, length 31.8 mm) at 600 rpm, and a time taken until vortex disappeared was measured as the unit of seconds, to calculate a vortex time.

(3) One Minute Absorption Capacity

1.0 g (W₃) of super absorbent polymer was put in a non-woven fabric envelope (15 cm×15 cm), and soaked in 500 mL of distilled water of 24° C. for 1 minute. After 1 minute, the envelope was taken out of the distilled water, and then, hung and left for 1 minute. And then, the weight (W₄) of the envelope was measured. And, the same operation was conducted without using super absorbent polymer, and then, the weight W₅ (g) at that time was measured.

Using the obtained masses, one minute absorption capacity (g/g) was calculated according to the following Calculation Formula 2.

[Calculation Formula 2]

One minute absorption capacity (distilled water)={[W[[5]]4 (g)−W[[ ]]₅ (g)−W₃ (g)]/W₃ (g)}

(4) Weight Average Particle Diameter (D50)

Weight average particle diameter (D50) was measured according to ERT420.2-02.

(5) Particle Size Distribution

The weight of super absorbent polymer classified according to particle size using a classification apparatus was measured.

In Examples 1 to 5 and Comparative Examples 1 to 4, particle size distribution and properties (centrifuge retention capacity, vortex time, one minute absorption capacity) are as shown in the following Table 1 and Table 2.

TABLE 1

| | | Comparative | Comparative | Comparative | Comparative |
|---|---|---|---|---|---|
| | | Example 1 | Example 2 | Example 3 | Example 4 |
| First rolls | Number of corrugations | 250 (0.32/mm) | | | |
| | (number of | | | | |
| | corrugations/circumference) | | | | |
| | First roll gap(mm) | 0.30 | | | |
| Second rolls | Number of corrugations | 500 (0.64/mm) | | | 800 (1.02/mm) |
| | (number of | | | | |
| | corrugations/circumference) | | | | |
| | Second roll gap(mm) | 0.20 | 0.15 | 0.10 | 0.30 |
| Particle size | 800 μm or more | 1.8 | 0.9 | 0.9 | 1.3 |
| distribution | 600 μm or more and | 26.5 | 19.0 | 19.4 | 20.5 |
| | less than 800 μm | | | | |
| | 500 μm or more and | 16.2 | 16.7 | 17.1 | 19.8 |
| | less than 600 μm | | | | |
| | 400 μm or more and | 17.1 | 19.8 | 20.2 | 20.8 |
| | less than 500 μm | | | | |
| | 300 μm or more and | 13.1 | 15.9 | 15.9 | 13.8 |
| | less than 400 μm | | | | |
| | 200 μm or more and | 9.7 | 11.4 | 10.9 | 9.6 |
| | less than 300 μm | | | | |
| | 150 μm or more and | 4.4 | 4.9 | 4.7 | 4.3 |
| | less than 200 μm | | | | |
| | less than 150 μm | 11.2 | 11.5 | 11.0 | 10.0 |
| | Weight average | 456 | 424 | 429 | 446 |
| | particle diameter | | | | |
| | (D50) (μm) | | | | |
| Properties | Centrifuge retention | 36.0 | 36.0 | 36.0 | 36.0 |
| | capacity(g/g) | | | | |
| | vortex(seconds) | 56 | 51 | 52 | 54 |
| | One minute absorption | 107 | 115 | 113 | 106 |
| | capacity(g/g) | | | | |

TABLE 2

| | | Example 1 | Example 2 | Example 3 | Example 4 | Example 5 |
|---|---|---|---|---|---|---|
| First rolls | Number of corrugations | 250 (0.32/mm) | | | | |
| | (number of | | | | | |
| | corrugations/circumference) | | | | | |
| | First roll gap(mm) | 0.30 | | | | 0.20 |
| Second rolls | Number of corrugations | 800 (1.02/mm) | | | | |
| | (number of | | | | | |
| | corrugations/circumference) | | | | | |
| | Second roll gap(mm) | 0.25 | 0.20 | 0.15 | 0.10 | 0.10 |
| Particle size | 800 μm or more | 0.7 | 0.3 | 0.2 | 0.1 | 0.1 |
| distribution | 600 μm or more and | 10.4 | 4.1 | 3.3 | 1.1 | 2.3 |
| | less than 800 μm | | | | | |
| | 500 μm or more and | 19.7 | 14.5 | 12.1 | 3.5 | 10.3 |
| | less than 600 μm | | | | | |
| | 400 μm or more and | 25.7 | 29.3 | 27.7 | 23.3 | 27.1 |
| | less than 500 μm | | | | | |
| | 300 μm or more and | 17.3 | 22.9 | 24.7 | 34.8 | 25.4 |
| | less than 400 μm | | | | | |
| | 200 μm or more and | 11.1 | 12.2 | 13.7 | 18.1 | 14.5 |
| | less than 300 μm | | | | | |
| | 150 μm or more and | 4.5 | 5.2 | 5.8 | 6.1 | 6.0 |
| | less than 200 μm | | | | | |
| | Less than 150 μm | 10.7 | 11.4 | 12.6 | 13.0 | 14.1 |
| | Weight average | 408 | 372 | 357 | 320 | 342 |
| | particle diameter | | | | | |
| | (D50) (μm) | | | | | |
| Properties | Centrifuge retention | 36.0 | 36.0 | 35.9 | 35.9 | 35.9 |
| | capacity(g/g) | | | | | |
| | Vortex(seconds) | 49 | 43 | 41 | 35 | 39 |
| | One minute absorption | 115 | 124 | 131 | 144 | 137 |
| | capacity(g/g) | | | | | |

Referring to Table 1 and Table 2, in Comparative Example 1 to Comparative Example 3 wherein the number of second corrugations (24) is 500 (the number of corrugations per unit circumference is about 0.64/mm), particles of 300 μm˜800 μm are mainly produced, but in Example 1 to Example 5 wherein the number of second corrugations (24) is 800 (the number of corrugations per unit circumference is about 1.02/mm), particles of 300 μm˜500 μm are mainly produced. Namely, if the number of second corrugations (24) increases from 500 to 800 (i.e., the number of corrugations per unit circumference increases from about 0.64/mm to 1.02/mm), particle size decreases and particle size distribution becomes narrow, and thus, the properties between products becomes uniform and surface treatment is facilitated. Particularly, vortex time less than 50 seconds and one minute absorption capacity of 115 g/g or more can be obtained without difference in centrifuge retention capacity.

Meanwhile, in the case of Comparative Example 4, the number of second corrugations (24) is 800 (the number of corrugations per unit circumference is about 1.02/mm), but the second roll gap (G2) is 0.30 mm, which is relatively large. Thus, in Comparative Example 4, particles of 300 μm˜800 μm are mainly produced, and vortex time is about 54 seconds, which is relatively slow, and one minute absorption capacity is about 106 g/g, which is relatively small. Thus, it can be seen even if the number of second corrugations (24) is increased, the second roll gap (G2) should be set 0.25 mm or less, preferably 0.20 mm or less.

And, in the case of Example 5, the first roll gap (G1) is 0.20 mm and the second roll gap (G2) is 0.10 mm, which are the smallest, but fine particles less than 150 μm are generated in the amount of 14.1%. The amount of fine particles generated in Example 5 is increased only by 3%, compared to Comparative Example 4 wherein the amount of fine particles generated is the smallest. To the contrary, the average particle size of Example 5 decreases by about 25% compared to the average particle size of Comparative Example 4, and thus, vortex time decreases by about 28%, and one-minute absorption capacity increases by about 30%. Namely, according to the embodiment of the invention, vortex time can be decreased and one-minute absorption capacity can be increased, without significant difference in the amount of fine particles generated.

And, comparing Comparative Example 2 (amount of fine particles: 11.5%) and Example 2 (amount of fine particles: 11.4%) having similar amount of fine particles generated, particles of 600 μm or more are generated in the amount of 19.9% in in Comparative Example 2, and in the amount of 4.4% in Example 2. Namely, according to the embodiment of the invention, at similar fine particle generation amount, the average size of particles can be reduced, and a narrow particle size distribution can be realized.

In summary, if the size of particles introduced in the roll mill is relatively large (for example, 1850 μm or more), it is preferable that the number of first corrugations (14) of the first rollers (10) is about 200˜about 300 (the number of corrugations per unit circumference is about 0.25/mm˜about 0.38/mm), and the number of second corrugations (24) of the second rollers (20) is about 700˜about 900 (the number of corrugations per unit circumference is about 0.89/mm˜about 1.15/mm). Namely, it is preferable that the first height (H1) of the first corrugations (14) is 950 μm˜about 1400 μm and the first pitch (P1) of the first corrugations (14) is about 2.62 mm˜about 3.93 mm, and the second height (H2) of the second corrugations (24) is about 276 μm˜about 354 μm and the second pitch (P2) of the second corrugations (24) is about 0.87 mm˜about 1.12 mm.

And, it is preferable that the first roll gap (G1) is about 0.20 mm˜about 0.30 mm, and the second roll gap (G2) is about 0.10 mm˜about 0.25 mm, more preferably about 0.10 mm˜about 0.20 mm.

### Comparative Examples 5 to 7 and Example 6

(Second Preparation Method of Super Absorbent Polymer)

Based on 100 g of acrylic acid, 6000 ppm of polyethyleneglycol diacrylate internal crosslinking agent, 60 ppm of AMA, 80 ppm of IRGACURE 819 photoinitiator, and 80 ppm of S-570 stabilizer were introduced and mixed to prepare a monomer solution. Subsequently, the monomer solution was continuously mixed with 167.5 g of an aqueous solution of 22.4% sodium hydroxide through a pump to prepare a neutralized monomer solution. Wherein, after confirming that the temperature of the neutralized monomer solution increased to about 72° C. or more by neutralization heat, we waited until the temperature was decreased to 40° C. When the temperature was decreased to 40° C., 2000 ppm of sodium bicarbonate blowing agent and 2500 ppm of sodium persulfate thermal initiator were added. The solution was poured into a polymerization reactor equipped with a light irradiation apparatus and pre-heated to 80° C., and light irradiation was conducted to photoinitiate. After light irradiation for 1 minute, reaction was additionally conducted for 2 minutes to obtain hydrogel polymer in the form of sheet.

1600 g of the hydrogel polymer was cut to a size of 3 cm length, 3 cm height, and then, mixed with 63 g of water containing 3000 ppm of sodium stearoyl lactylate, and then, poured into a chopper having a hole size of 3 mm to chop the hydrogel polymer sheet two times. The chopped gel was dried by moving type drying to 205° C. in a paddle type dryer. Wherein, the average particle size was 1319 μm.

### Comparative Example 5

The super absorbent polymer obtained by the second preparation method was ground using one pair of first rollers wherein the number of first corrugations (14) is 250 (the number of corrugations per unit circumference is about 0.32/mm, H1=1190 μm, P1=3.14 mm), and the first roll gap (G1) is 0.3 mm. And then, particle size distribution was analyzed using a mesh type classification sieve.

### Comparative Example 6

The super absorbent polymer obtained by the second preparation method was ground using one pair of first rollers wherein the number of first corrugations (14) is 250 (the number of corrugations per unit circumference is about 0.32/mm, H1=1190 μm, P1=3.14 mm), and the first roll gap (G1) is 0.3 mm, and one pair of second rollers (20) wherein the number of second corrugations (24) is 500 (the number of corrugations per unit circumference is about 0.64/mm, H2=530 μm, P2=1.57 mm), and the second roll gap (G2) is 0.2 mm. And then, particle size distribution was analyzed using a mesh type classification sieve.

### Comparative Example 7

The same process as Comparative Example 5 was conducted, except that the number of the first corrugations (14) is 500 (the number of corrugations per unit circumference is about 0.64/mm, H1=530 μm, P1=1.57 mm), and the first roll gap (G1) is 0.2 mm.

### Example 6

The same process as Comparative Example 5 was conducted, except that the number of the first corrugations (14) is 800 (the number of corrugations per unit circumference is about 1.02/mm, H1=310 μm, P1=0.98 mm), and the first roll gap (G1) is 0.2 mm.

In Comparative Examples 5 to 7 and Example 6, particle size distributions are as shown in the following Table 3.

TABLE 3

| | | Comparative | Comparative | Comparative | |
|---|---|---|---|---|---|
| | | Example5 | Example6 | Example7 | Example6 |
| First roller | Number of corrugations | 250 (0.32/mm) | | 500 (0.64/mm) | 800 (1.02/mm) |
| | (number of corrugations/ | | | | |
| | unit circumference) | | | | |
| | First roll gap(mm) | 0.3 | | 0.2 | 0.2 |
| Second rollers | Number of corrugations | — | 500 (0.64/mm) | — | — |
| | (number of corrugations/ | | | | |
| | unit circumference) | | | | |
| | Second roll gap(mm) | | 0.2 | | |
| Particle size | 800 μm or more | 51 | 1 | 2 | 0 |
| distribution | 600 μm or more and | 20 | 18 | 25 | 5 |
| | less than 800 μm | | | | |
| | 400 μm or more and | 13 | 41 | 38 | 60 |
| | less than 600 μm | | | | |
| | 300 μm or more and | 6 | 16 | 13 | 17 |
| | less than 400 μm | | | | |
| | 150 μm or more and | 6 | 17 | 15 | 12 |
| | less than 300 μm | | | | |
| | Less than 150 μm | 3.0 | 5.9 | 6.0 | 5.3 |
| | Weight average | 810 | 448 | 494 | 431 |
| | particle diameter | | | | |
| | (D50) (μm) | | | | |

Referring to Table 3, it can be seen that in Comparative Example 5 wherein the number of first corrugations (14) is 250 (the number of corrugations per unit circumference is about 0.32 mm) and the first roll gap (G1) is 0.3 mm, and Comparative Example 7 wherein the number of first corrugations (14) is 500 (the number of corrugations per unit circumference is about 0.64/mm) and the first roll gap (G1) is 0.2 mm, particles of 600 μm or more are generated in the amount of 71% and 27%, respectively, and the average particle sizes are respectively 810 μm, 494 μm, which are relatively large.

To the contrary, it can be seen that in Example 6 wherein the number of first corrugations (14) is 800 (the number of corrugations per unit circumference is about 1.02/mm) and the first roll gap (G1) is 0.2 mm, particles of 600 μm or more are generated in the amount of 5%, and the average particle size is 431 μm, which is relatively small. Thus, even if one pair of rollers are used, the average particle size can be reduced by increasing the number of first corrugations (14)(i.e., the number of first corrugations (14) per unit circumference) and maintaining the first roll gap (G1) as 0.2 mm. Commonly, if the average particle size decreases, there is no significant difference in centrifuge retention capacity, but vortex becomes significantly rapid and one-minute absorption capacity significantly increases.

Meanwhile, in Comparative Example 6 wherein the number of first corrugations (14) is 250 (the number of corrugations per unit circumference is about 0.32/mm) and the first roll gap (G1) is 0.3 mm, and the number of second corrugations (24) is 500 (the number of corrugations per unit circumference is about 0.64/mm) and the second roll gap (G2) is 0.2 mm, particles of 600 μm or more are generated in the amount of 19%, and the average particle size is 448 μm. Namely, compared to the case of using two pairs of first, second rollers (10,20) having corrugation number of 500 (the number of corrugations per unit circumference is about 0.64/mm), when using one pair of first rollers (10) having corrugation number of 800 (the number of corrugations per unit circumference is about 1.02/mm), generation of large particles may be reduced (namely, particle size distribution becomes uniform), and the average particle size may be decreased.

In summary, if the size of particles introduced in the roll mill is relatively small (for example, less than 1850 μm), a roll mill comprising only one pair of first rollers (10) can be used. However, it is preferable that the number of first corrugations (14) of the first roller (10) is about 700˜about 900 (the number of corrugations per unit circumference is about 0.89/mm˜about 1.15/mm). It is preferable that the first height (H1) of the first corrugations (14) is about 276 μm˜about 354 μm, and the first pitch (P1) of the first corrugations (14) is about 0.87 mm˜about 1.12 mm. It is also preferable that the first roll gap (G1) is about 0.10 mm˜about 0.25 mm, more preferably 0.10 mm˜about 0.20 mm.

Although preferable embodiments of the invention have been explained, the technology is not limited to the embodiments, and includes all the modifications within a range easily modified from the embodiments of the invention by a person having ordinary knowledge in the art and recognized as being equivalent.

### DESCRIPTION OF SYMBOLS

| | |
|---|---|
| 10, 20: first, second rollers | 12, 22: first, second rotation axes |
| 14, 24: first, second corrugations | 30: particles |
| G1, G2: first, second roll gaps | D1, D2: first, second diameters |
| H1, H2: first, second heights | P1, P2: first, second pitches |

1. A roll mill for super absorbent polymer which grinds super absorbent polymer particles and discharges them, the roll mill comprising:
one pair of rollers having a plurality of corrugations disposed on each outer perimeter surface of the one pair of rollers, the one pair of rollers being arranged parallel to each other while being spaced apart by a roll gap,
wherein
a number of corrugations per unit circumference of each of the one pair of rollers is in a range of 0.89/mm˜1.15/mm.

2. The roll mill according to claim 1, wherein a height of the plurality of corrugations is in a range of 276 μm˜354 μM, and wherein a pitch of the plurality of corrugation is 0.87 mm˜1.12 mm.

3. The roll mill for super absorbent polymer according to claim 1, wherein the roll gap is in a range of 0.10 mm˜0.25 mm.

4. The roll mill for super absorbent polymer according to claim 1, wherein the roll gap is in a range of 0.10 mm˜0.20 mm.

5. The roll mill according to claim 1, further comprising another pair of rollers disposed in the roll mill prior to said one pair of rollers, wherein a presence of another pair of rollers is determined according to a size of super absorbent polymer particles configured to be introduced to the roll mill.

6. The roll mill according to claim 5, wherein said another pair of rollers have a plurality of different corrugations formed on each outer perimeter surface of the another pair of rollers, the another pair of rollers being arranged parallel to each other while being spaced apart by a different roll gap,
Wherein a number of the plurality of different corrugations per unit circumference of each of the another pair of rollers is in a range of 0.25/mm˜0.38/mm.

7. The roll mill according to claim 6, wherein a height of the plurality of different corrugations is in a range of 950 μm˜1400 μm, and wherein a pitch of the plurality of different corrugations is in a range of 2.62 mm˜3.93 mm.

8. The roll mill according to claim 6, wherein the different roll gap is in a range of 0.20 mm˜0.30 mm.

9. A method for preparing super absorbent polymer, comprising:
polymerizing a monomer composition, wherein the monomer composition includes water soluble ethylenically unsaturated monomers having at least partially neutralized acid groups, an internal crosslinking agent, and a polymerization initiator, so as to prepare a hydrogel polymer;
chopping or micronizing the hydrogel polymer;
drying a micronized hydrogel polymer, so as to prepare a dried super absorbent polymer particles; and
grinding the dried super absorbent polymer particles;
wherein the grinding is conducted using the roll mill according to claim 1.

10. A method for preparing super absorbent polymer, comprising steps of:
polymerizing a monomer composition, wherein the monomer composition includes water soluble ethylenically unsaturated monomers having acid groups, an internal crosslinking agent, and a polymerization initiator, so as to prepare a hydrogel polymer;
neutralizing at least a part of the acid groups of the hydrogel polymer;
micronizing the hydrogel polymer in a presence of a surfactant, so as to prepare hydrated super absorbent polymer particles;
drying the hydrated super absorbent polymer particles, so as to prepare dried super absorbent polymer particles; and
grinding the dried super absorbent polymer particles;
wherein the grinding is conducted using the roll mill according to claim 1.
